(19) United States
(12) Patent Application Publication
(10) Pub. No.: US 2008/0031701 A1
(43) Pub. Date: Feb. 7, 2008

(54) Expansion Rivet

(75) Inventors: Mohieddine Boubtane, Grenoble (FR); Yann Ranval, Vaulnaveys le Bas (FR); Jean-Jacques Legat, Colombe (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/572,783

(22) PCT Filed: May 6, 2005
(86) PCT No.: PCT/EP05/04934

§ 371 Date: Jan. 26, 2007

(30) Foreign Application Priority Data
Jul. 28, 2004 (DE) 102004036621.7

(51) Int. Cl. F16B 19/10

(52) U.S. Cl. 411/80.1

(57) ABSTRACT

An expansion rivet comprises a holding element (1) provided with a bearing plate (2) and legs (7). An actuating element (11) provided with a head plate (12) and a shank (13) is also present. In a locking position, the head plate (12) abuts the bearing plate (2). The engagement of expansion projections in an active region causes the legs (7) to be splayed outwardly. Attached to the shank (13) is at least one projecting detent lug (17), which is shallowly beveled away from the head plate (12) via a sliding surface (18) and is set at a steep angle confronting the head plate (12) via a reverse detention surface (19). In this way, after the actuating element (11) has been inserted into the holding element (1), the expansion rivet can very easily be released and reused by releasing the head plate (12) from the bearing plate (2) and pulling out the actuating element (11) against the direction of insertion until the or each reverse detention surface (19) butts against the bearing plate (2) and the expansion rivet can be removed.

### BACKGROUND OF THE INVENTION

1. Field of the Invention

The present invention relates to an expansion rivet.

2. Description of the Related Art

One expansion rivet is known from EP 1 375 931 A1. This previously known expansion rivet is provided with a holding element comprising a number of radially outwardly splayable legs and a bearing plate to which the legs are attached. An actuating element comprising a shank and able to be inserted into the holding element through a passthrough recess of the bearing plate is also present. In a locking position of the actuating element, the legs are splayed radially outwardly by the engagement of expansion projections disposed in an active region of the legs. The actuating element is provided with a head plate which abuts the bearing plate in the locking position. Also present are detent lugs, which are attached to the shank and protrude beyond a lateral surface thereof that is configured snugly with the passthrough recess, and which are shallowly beveled away from the head plate via a sliding surface and are set at a steep angle confronting the head plate via a reverse detention surface. Said detent lugs are disposed at a distance from the head plate that is adapted such that when the reverse detention surfaces abut the head plate, the shank is free of engagement with the expansion projections. In this expansion rivet, the actuating element and, correspondingly, the passthrough recess have a roundish cross section, the detent lugs being arranged at a 90 degree angle on the outside of solid, radially extending webs and sliding in recesses assigned to them. Aligning the actuating element for insertion into the holding element is not made very easy by this means, since no direction of execution is specified. There is also a risk that the detent lugs may be sheared off as a result of relative rotation between the holding element and the actuating element.

Another expansion rivet very similar to the aforesaid embodiment is known from WO 03/072957 A2.

Another expansion rivet is known from U.S. Pat. No. 5,201,623. This expansion rivet is provided with a holding element comprising at least two radially outwardly splayable legs and a bearing plate to which the legs are attached. The legs are provided with inwardly directed expansion projections. The previously known device further comprises an actuating element composed of a shank on which a projection arrangement is formed. In an installed position, the expansion projections are disposed in indentations of the projection arrangement, so that the legs extend substantially parallel to the shank and the expansion rivet can be inserted in a seating recess extending for example through a substrate element and a bearing element. In a locking position of the actuating element, after the shank has been moved axially in the direction of insertion, the legs are splayed outwardly due to the engagement of the projection arrangement with the expansion projections in an active region. The expansion rivet can be locked in the seating recess in this way.

To release the expansion rivet, the shank is pushed axially farther in the insertion direction until the expansion projections come to rest in additional indentations of the projection arrangement and the legs again extend substantially parallel to the shank. The expansion rivet can now be removed from the seating recess. For the expansion rivet to be reused, the shank must be moved back to the installed position against the direction of insertion. This has proven to be relatively bothersome, however, and causes not inconsiderable wear, particularly on the expansion projections and the projection arrangement, due to the need to pass through the locking position in two directions for one seating and release cycle.

Known from EP 0 682 186 A1 is an expansion rivet in which a head plate of an actuating element can be inserted in an insertion recess provided in a bearing plate of a holding element.

### SUMMARY OF THE INVENTION

The present invention provides an expansion rivet, which is distinguished by simple insertion and high resistance to twisting of the actuating element relative to the holding element.

By virtue of the configuration of the present expansion rivet, the actuating element can be inserted with relatively low insertion forces into the holding element, in an easily recognizable orientation with respect thereto, until the detent lugs catch behind the head plate, since the detent lugs can be deformed relatively easily on encountering the plinth pieces during insertion. Due to the cornered form of the cross section of the shank of the actuating element and of the passthrough recess, the detent lugs are well protected against the shear forces they would be subjected to as a result of relative rotation between the holding element and the actuating element.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of an expansion rivet according to the invention;

FIG. 2 is a section through a shank of an actuating element of the inventive expansion rivet according to FIG. 1;

FIG. 3 is a side view of the exemplary embodiment according to FIGS. 1 and 2 with the actuating element in an installed position; and

FIG. 4 is a side view of the exemplary embodiment according to FIGS. 1 to 3 with the actuating part disposed in a seating recess in a locking position.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

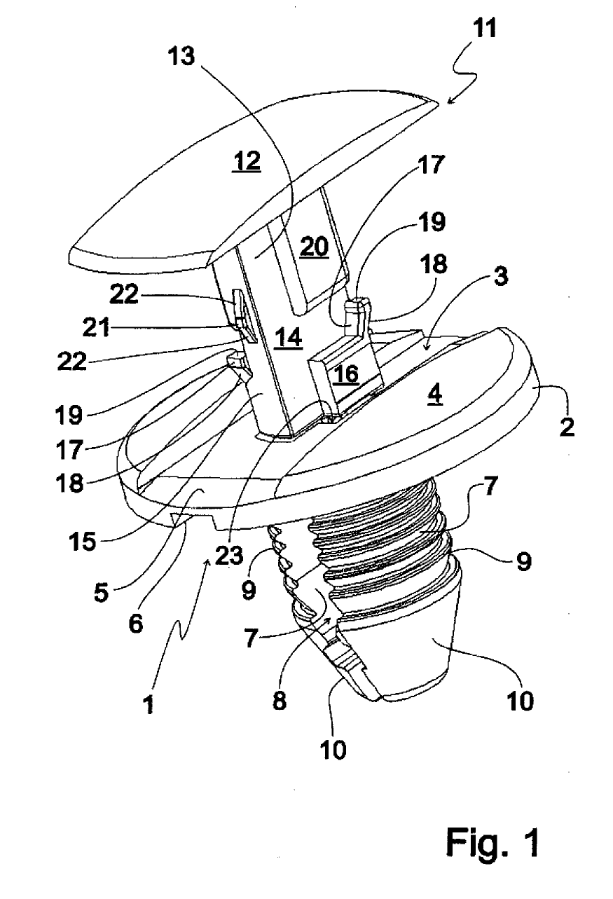

FIG. 1 is a perspective view of an exemplary embodiment of an expansion rivet according to the invention. The expansion rivet according to FIG. 1, which is made of plastic, is provided with a holding element 1 equipped with a flat bearing plate 2, circular-shaped in this exemplary embodiment. Formed in the bearing plate 2 is a diametrically extending insertion recess 3, which is open toward a cover side 4 of bearing plate 2. A bevel 5 is formed in a marginal region of insertion recess 3 to serve as a tool application structure.

Attached to bearing plate 2 on a bearing side 6 disposed opposite the cover side 4 of bearing plate 2 are two legs 7, which are oriented substantially at right angles to bearing plate 2 and are disposed laterally spaced apart from each other, a shank recess 8 thus being formed between the legs 7. In a region adjoining bearing plate 2, the legs 7 comprise circumferentially extending detent rings 9, while the free ends of the legs 7, i.e. the opposite ends from bearing plate 2, are configured with conical portions 10 ascending toward bearing plate 2 from the outer edge of the free ends.

The exemplary embodiment of an inventive expansion rivet according to FIG. 1 is further provided with an actuating element 11, which is configured with a head plate 12 and a shank 13 attached to said head plate 12 and oriented substantially at right angles thereto. Shank 13 has a cornered cross section with two broad lateral surfaces 14 and two narrow lateral surfaces 15, respectively disposed opposite each other in pairs.

Formed on the broad lateral surfaces 14 are projecting plinth pieces 16, which are disposed at a distance from head plate 12 and to which are attached detent lugs 17 that point toward head plate 12 and protrude beyond narrow lateral surfaces 15. The detent lugs 17 are shallowly beveled away from head plate 12 via sliding surfaces 18, and are set at a steep angle confronting head plate 12 via reverse detention surfaces 19. In prolongation of the plinth pieces 16 in the direction of head plate 12, fill-in pieces 20 dimensioned in accordance with plinth pieces 16 and adjoining head plate 12 are attached to the broad lateral surfaces 14.

Attached to narrow lateral surfaces 15, between head plate 12 and each of detent lugs 17, is a locking projection 21 that is shallowly beveled both toward head plate 12 and away from head plate 12 via canted surfaces 22.

In the representation of FIG. 1, the shank 13 of actuating element 11 is inserted section by section into holding element 1 via a passthrough recess 23 provided in bearing plate 2 and dimensioned to correspond to the cross section of the shank 13 in the region both of the plinth pieces 16 and of the fill-in pieces 20.

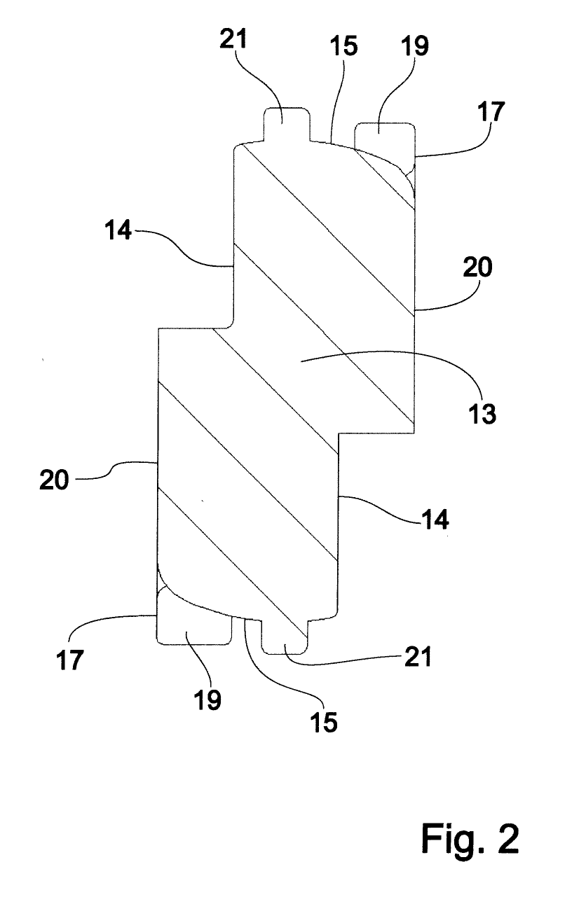

FIG. 2 is a section through the shank 13 of actuating element 11 of the inventive expansion rivet according to FIG. 1 in the region of the locking projections 21, looking toward the detent lugs 17. It is clearly apparent from FIG. 2 that the detent lugs 17 protrude beyond the periphery of shank 13 via their reverse detention surfaces 19 confronting head plate 12 and oriented at right angles to shank 13.

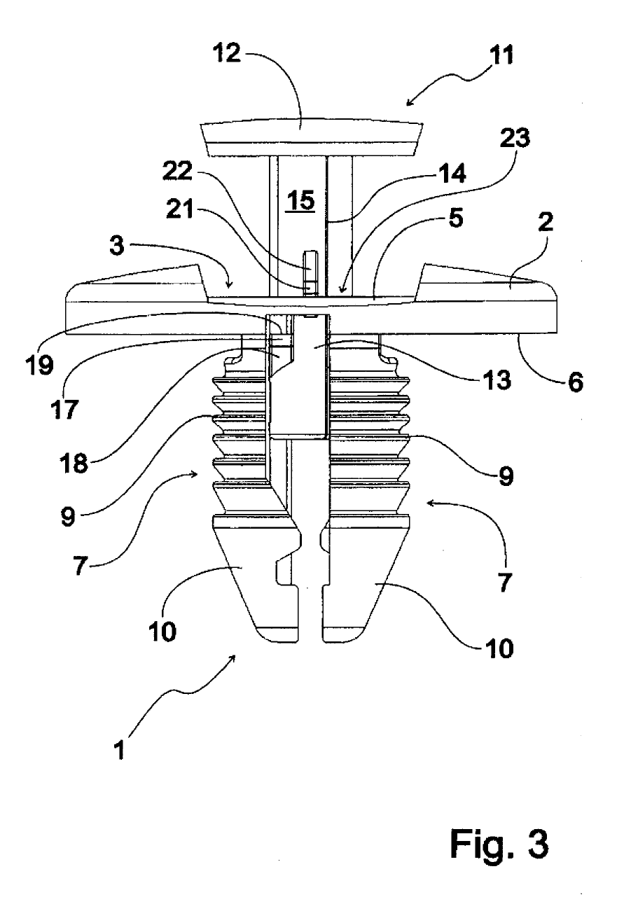

FIG. 3 is a side view of the exemplary embodiment according to FIG. 1 with the actuating element 11 in an installed position, in which the shank 13 of actuating element 11 has been inserted through the passthrough recess 23 between legs 7 to an extent such that the locking projections 21 bear against the edge of passthrough recess 23 and the detent lugs 17 engage behind bearing plate 2 on the side comprising the legs 7 and abut bearing side 6.

The transposition of actuating element 11 from the position shown in FIG. 1 to the installed position according to FIG. 3 is made possible by the fact that the detent lugs 17 slide by their sliding surfaces 18 along the edge of passthrough recess 23 until, due to the relative elasticity of the plastic material of the reverse detention surfaces 19, they engage behind bearing plate 2 on its bearing side 6. In the illustrated exemplary embodiment of an expansion rivet according to the invention, the distance, in the longitudinal direction of the shank 13, between reverse detention surfaces 19 and locking projections 21 is approximately equal to the thickness of bearing plate 2 in the region of passthrough recess 23, so that in the installed position according to FIG. 3, actuating element 11 is secured against further insertion into holding element 1 up to a certain amount of applied force.

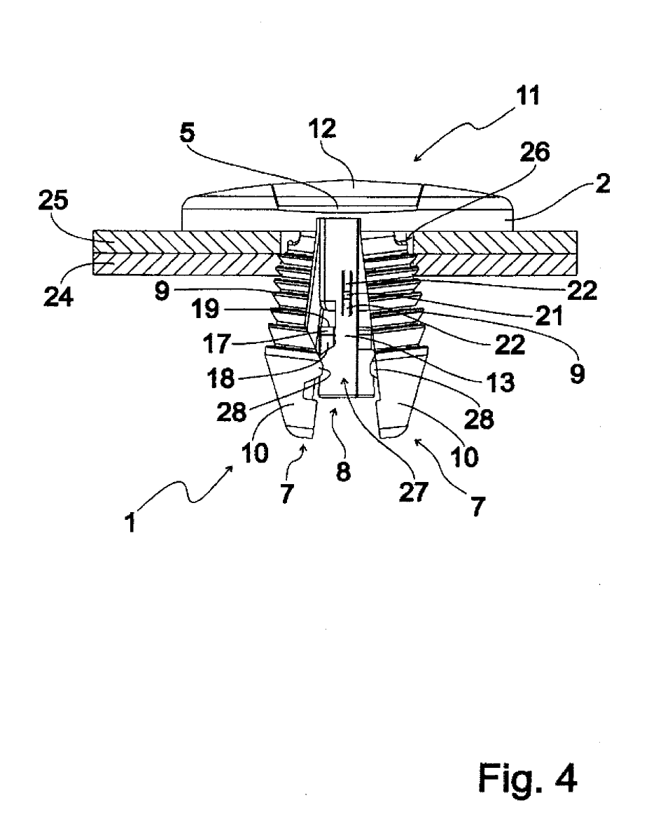

FIG. 4 is a side view of the exemplary embodiment according to FIGS. 1 to 3, inserted, in a locking position, into a seating recess 26 formed in a flat substrate element 24 and in a bearing element 25 laid on said substrate element 24, and which in said locking position unites bearing element 25 with substrate element 24. In the locking position, shank 13 is inserted into shank recess 8 to an extent such that the free end 27 of shank 13, i.e. the opposite end from head plate 12, enters into engagement, in an active region, with mutually confronting expansion projections 28 formed on legs 7. When the free end 27 of shank 13 engages with expansion projections 28, the legs 7 are splayed outward, making it possible to anchor the expansion rivet in the seating recess 26 over a relatively large range of thicknesses for substrate element 24.

As can be appreciated with particular clarity from FIG. 4, the head plate 12 is configured such that in the locking position it fits tightly into the insertion recess 3 of bearing plate 2 of holding element 1.

The expansion rivet according to the invention can be removed from the seating recess 26 by placing the flat end of a screwdriver or other similarly shaped tool on bevel 5 and lifting head plate 12 of actuating element 11 out of insertion recess 3, and then grasping it for example between two fingers and exerting a pulling force against the direction of insertion until the locking projections 21 emerge from passthrough recess 23 and the reverse detention surfaces 19 of detent lugs 17 abut the bearing side 6 of bearing plate 2, causing the legs 7, due to their inherent elasticity, to automatically revert to a mutually substantially parallel position. In the now-restored installed position according to FIG. 3, the expansion rivet can be extracted from seating recess 26 and reused.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-6. (canceled)

7. An expansion rivet, comprising:
a holding element (1) provided with at least two radially outwardly splayable legs (7) and a bearing plate (2) to which said legs (7) are attached;
an actuating element (11) provided with a shank (13) and insertable into said holding element (1) through a passthrough recess (23) of said bearing plate (2), wherein in a locking position of said actuating element (11) said legs (7) are splayed outwardly by the engagement of expansion projections (28) disposed on said legs (7), and wherein said actuating element (11) comprises a head plate (12) which in the locking position abuts said bearing plate (2);
at least one detent lug (17) attached to said shank (13) and protruding beyond a lateral surface (15) of said shank (13) which is shallowly beveled away from said head plate (12) via a sliding surface (18) and is set at a steep angle confronting said head plate (12) via a reverse detention surface (19), each said detent lug (17) disposed at a distance from said head plate (12) which is adapted such that when said reverse detention surface (19) abuts said bearing plate (2), said shank (13) is free of engagement with said expansion projections (28);
a cornered cross section on said shank (13) with two each of broad lateral surfaces (14) and narrow lateral surfaces (15), respectively disposed opposite each other in pairs;
at least one projecting plinth piece (16) formed on said broad lateral surfaces (14) which is spaced from said head plate (12) and to which are attached said detent lugs (17) that point toward said head plate (12) and protrude beyond said narrow lateral surfaces (15);
at least one fill-in piece (20) attached to said broad lateral surfaces (14) and dimensioned in accordance with said plinth pieces (16) and adjoining said head plate (12), said passthrough recess (23) adapted to the dimensions of said shank (13) in the region both of said plinth pieces (16) and of said fill-in pieces (20).

8. The expansion rivet of claim 1, wherein each said reverse detention surface (19) is oriented at right angles to said shank (13).

9. The expansion rivet of claim 1, further comprising at least one outwardly protruding locking projection (21) formed on said shank (13) between said head plate (12) and each said detent lug (17).

10. The expansion rivet of claim 9, wherein the distance between each said detent lug (17) and each said locking projection (21) corresponds to the thickness of said bearing plate (2) in the region of said passthrough recess (23).

11. The expansion rivet of claim 1, wherein said bearing plate (2) further comprises an insertion recess (3) into which said head plate (12) is insertable in the locking position.

12. The expansion rivet of claim 1, wherein at least one of said head plate (12) and said bearing plate (2) comprises a tool application structure (5) for applying a tool in order to lift said head plate (12) off said bearing plate (2).
